(19) United States
(12) Patent Application Publication
(10) Pub. No.: US 2007/0048577 A1
(43) Pub. Date: Mar. 1, 2007

(54) SCALABLE MICROBIAL FUEL CELL WITH FLUIDIC AND STACKING CAPABILITIES

(75) Inventors: Bradley R. Ringeisen, Lorton, VA (US); Emily M. Henderson, Cincinnati, OH (US); Peter K. Wu, Ashland, OR (US); Jeremy J. Pietron, Washington, DC (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: THE GOVERNMENT OF THE UNITED STATES OF AMERICA, AS REPRESENTED BY THE SECRETARY OF THE NAVY NAVAL RE, Washington, DC (US)

(21) Appl. No.: 11/308,216

(22) Filed: Mar. 13, 2006

Related U.S. Application Data
(60) Provisional application No. 60/712,611, filed on Aug. 30, 2005.

(51) Int. Cl. H01M 8/02; H01M 4/86; H01M 4/96; H01M 8/16; H01M 4/90

(52) U.S. Cl. 429/30; 429/38; 429/33; 429/44; 429/32; 429/13; 429/2; 429/43

(57) ABSTRACT

A fuel cell having: a proton exchange membrane; anode and cathode housings containing chambers; a three-dimensional anode and cathode. Each housing may have a feed passage, a waste passage, and two through passages. The anode feed passage and the anode waste passage are each coupled to the anode chamber and to one of the cathode through passages and vice versa. The anode chamber may have bacteria capable of donating electrons to the anode upon exposure to a fuel. Solutions may be circulated through the passages and chambers.

### CROSS REFERENCE TO RELATED APPLICATIONS

This application claims the benefit of U.S. Provisional Patent Application No. 60/712,611, filed on Aug. 30, 2005 incorporated herein by reference.

### FIELD OF THE INVENTION

The invention is generally related to fuel cells.

### DESCRIPTION OF RELATED ART

Microbial fuel cells (MFCs) offer a clean, renewable, and potentially autonomous source of energy that could be an alternative to environmental power sources such as solar, geothermal, and wind. They rely upon the metabolic cycle of living bacteria to generate electrons that are then harvested by the anode and transferred to the cathode where a complementing reduction reaction occurs.

Due to their ability to function in many environments with versatile fuels, microbial fuel cells (MFCs) are a promising power source for applications under extreme or highly variable conditions where other power sources might fail (anaerobic conditions, varying temperature, low/no solar energy, long periods without fuel, etc.). In addition, MFCs possess the ability to function over years, in some cases harvesting energy from the environment by utilizing indigenous nutrients or carbon sources as fuel. Biofuel cells have some advantages over batteries or solar cells for applications such as powering autonomous miniature sensors or sensor networks. Many homeland security, military, and medical applications for miniature sensors make recharging or replacing batteries impossible (i.e., dangerous or remote locations, in vivo, etc.), while other applications may require power sources to function in environments where there is limited or no solar light (i.e., caves, forests, seafloor, in vivo, etc.).

Microbial fuel cells hold the potential to become an autonomous power source (i.e., gathering and utilizing nutrients directly from the environment), eliminating the need for human supplied nutrients, fuel, or re-charging. Possible examples of this are MFCs utilizing environmental fuels such as tree sap or carbon sources naturally occurring in soil or the ocean columns. Potential uses for miniaturized microbial fuel cells include, but are not limited to, nano-electrical mechanical systems, micro-electrical mechanical systems, in vivo power source for continuous health monitoring or drug delivery, stealthy sensor networks and grids (land/sea) for chem/bio detection or acoustic monitoring, and an alternative to solar, geothermal, wind, etc., for low power applications.

The concept of using energy scavenged from environmental sources to power small sensor nodes has been validated (Roundy et al., “A study of low level vibrations as a power source for wireless sensor nodes, ” Computer Comm., 2003, 26, 1131-1144; Roundy et al., “A 1 .9 GHz RF transmit beacon using environmentally scavenged energy,” Dig. IEEE Int. Symposium on Low Power Elec. and Devices (ISLPED), Seoul, Korea, 2003). A sensor node is defined as a device consisting of a sensor, a transceiver, and supporting electronics, which are all connected to a larger wireless network. Due to their simplicity and dependability, batteries are good choices for sensor nodes for short-term applications (1-2 yrs). For nodes that need to function longer, energy harvesting power sources such as photovoltaic cells, piezoelectric conversion of vibration, and biofuel cells may be necessary. Energy scavenging sources theoretically can maintain constant power densities indefinitely (10-300 μW/cm³ for vibrations, temperature gradient, and cloudy solar to 15,000 μW/cm³ for direct sun), assuming that the scavenged substrate is maintained at constant levels in the environment. This assumption is particularly flawed for solar power due to dramatic drops in power density, depending upon several uncontrollable environmental conditions.

The basic design of a macroscopic microbial fuel cell includes the following: (1) an anaerobic anode chamber with a volume of 200-2000 mL that contains a solution of bacteria and possibly electron shuttles/mediators as well as a conductive anode, (2) a cathode chamber with an equal volume that is oxygen rich, contains a conductive cathode, and biocatalysts that promote oxidation reactions, and (3) a proton exchange membrane (PEM), usually NAFION®, that is placed in a channel that separates the anode and cathode chamber. There are many variations on these devices that include: (1) an air-exposed cathode, (2) a mediator-less anode chamber that utilizes special bacteria that can directly donate electrons to the anode, (3) electrically-conducting polymers coated onto the anode for protection and electron shuttling, (4) Fe and Mn-traced anodes that eliminate the need for solution- borne electron shuttles, (5) seafloor devices that eliminate the need for the PEM by placing the anode in sediment and the cathode in open ocean water, (6) devices run off of sewage sludge for both delivery of nutrients and bacteria, (7) single chamber devices that eliminate the PEM (membraneless) other than seafloor devices.

These macroscopic devices may not be optimized in terms of proton transport from the anode chamber to the cathode chamber. Usually these devices include a “bottleneck” passage or channel where the PEM separates the two chambers. This design limits proton conductance, or throughput, and lowers the efficiency of the device. The macroscopic scale of the chambers is not designed for efficiency, that is to say, a majority of bacteria present in the chamber do not contribute their electrons to the anode due to their large average distance from the anode. In addition, attempts are not made in these designs to flow fluid through the chambers, resulting in potential mass transfer limits on power production.

Due to natural nutrient supplies, microbial fuel cells (MFCs) have been shown to generate continuous power for many years in aquatic environments. However, these demonstrations have been limited to the seafloor and riverbeds in order to maintain an anoxic environment for the anode (sub-sediment). Previous studies have shown that anaerobic andaerobic Shewanella oneidensis DSP10 strain can reduce Cr(VI) to Cr(III), demonstrating that electrons from the bacteria can be used to reduce metals in the presence of oxygen (Lowe et al., “Aerobic and anaerobic reduction of Cr(VI) by Shewanella oneidensis effects of cationic metals, sorbing agents and mixed microbial cultures” Acta Biotechnologica 23 (2003) 161-178. Many MFCs utilize strains of bacteria that expire when exposed to aerobic environments for extended periods of time (Geobacter sp., Clostridium sp., etc.), eliminating their ability to donate electrons to the anode in the presence of oxygen (Shukla et al., “Biological fuel cells and their applications” Current Science 87 (2004) 455-468; Liuet al., “Power generation in fed-batch microbial fuel cells as a function of ionic strength, temperature, and reactor configuration” Eviron. Sci. Technol. 39 (2005) 5488-5493; Bond et al., “Electricity production by Geobacter sulfurreducens attached to electrodes” App. Env. Microbiology 69 (2003) 1548-1555; Liu et al., “Production of electricity during wastewater treatment using a single chamber microbial fuel cell” Environ. Sci. Technol.. 38 (2004) 2281-2285). Recent studies on Geobacter sulferreducens indicate a slight tolerance to oxygen (up to 24 hrs), but the ability to utilize the microbe for current production under these conditions was not investigated (Lin et al., “Geobacter sulferreducens can grow with oxygen as a terminal electron acceptor” App. Environ. Microbiol. 70 (2004) 2525-2528). In addition, the prospect of boosting output power by using hydrogen is impossible in an aerobic environment because hydrogen is evolved only under anaerobic culture conditions. One macroscopic MFC maintained with anaerobic Shewanella putrefaciens reported no power generation when switching the culture to aerobic respiration, but this MFC had such low power density (5 μW/m² per true anode surface area) it is possible that the aerobic MFC produced lower power rather than no power (Kim, et al. “A mediator-less microbial fuel cell using a metal reducing bacterium, Shewanella putr.”Enzyme Microbial Technol. 30 (2002) 145-152). Other work has shown that higher Coulombic efficiencies can be achieved in H-cell MFCs by utilizing chemical and biological methods to reduce trace levels of oxygen in the anode chamber that cross over from the aerobic cathode (Min et al., “Electricity generation using membrane and salt bridge microbial fuel cells” WaterResearch 39 (2005) 1675-1686). This increased efficiency is attributed to the near-elimination of electron scavenging by oxygen in the anode chamber, thereby allowing more electrons to be donated to the anode.

A smaller-scale design has been disclosed. Lin et al. (Proceedings of IEEE Micro Electro Mechanical Systems Conference, pp. 383-386, Kyoto, Japan (January 2003)) present a microfluidic MFC with an anode as the surface of a microfluidic channel. This design allows nutrients to be continuously flowed over the anode. In addition, the PEM is placed in close proximity to both the anode and cathode and completely covers the area of the electrodes. This promotes proton conductance rather than limiting it. The small volume of the anode channel also greatly reduces the number of bacteria that do not contribute electrons to the anode.

However, there are drawbacks to Lin's device. By using traditional microfabrication and lithographic techniques, Lin created a 2D device that uses a thin 2D anode and cathode. These electrodes have relatively small surface areas (0.5 cm²) and cannot be enhanced without making the device footprint larger. Secondly, Lin's device is not scalable, limiting it to micro-scale power generation and severely limited power regimes. Finally, Lin's device cannot be efficiently stacked or linked into series or parallel circuits, two highly desirable advantages of creating a miniature device. Each of these limitations reduces the usefulness of this invention, because there may be no applications suitable for the amounts of power potentially generated by such a device.

The amount of current and power generated by the 2D microfabricated device described in the proceeding paper above are roughly 0.5 to 5 μA and 10-250 μW, respectively. The reported measurements were highly variable and performed over only a matter of minutes compared to months or even years for most macroscopic microbial fuel cells.

Without novel designs or scientific breakthroughs, the energy output of a miniaturized device would be limited to nW's or less due to the current 2D micro-fabricated design, resulting in smaller electrode surface area and the inability to efficiently stack and wire the cells together. The present microbial fuel cell may function in either aerobic or anaerobic environments, can be 10-100 times smaller than traditional microbial fuel cells (with the potential in the design to be shrunk to 10³ to 10⁴ times smaller), and has been shown to generate continuous power for weeks. In addition, this design may be scalable, enable several cells to be efficiently stacked in 3D for wiring series or parallel circuits, and allow for complex and highly porous 3D conducting structures to be added to the anodic and cathodic chambers, creating orders of magnitude higher surface area electrodes than currently disclosed designs. In addition, the design has the adaptability to use 3D electrodes that have the potential to enable orders of magnitude higher current and power generation.

### BRIEF SUMMARY OF THE INVENTION

The invention comprises a fuel cell comprising: a proton exchange membrane, an anode housing, a cathode housing, a three-dimensional anode, and a three-dimensional cathode. The anode housing comprises an anode feed passage and an anode waste passage. The cathode housing comprises two cathode through passages. The anode has a surface to volume ratio of about 50-5000 cm²/cm³. The anode housing and the proton exchange membrane together define an anode chamber containing the anode within the anode housing. The cathode housing and the proton exchange membrane together define a cathode chamber containing the cathode within the cathode housing. The anode feed passage and the anode waste passage are each coupled to the anode chamber and to one of the cathode through passages.

The invention further comprises a method of generating power comprising: providing the above fuel cell; placing in the anode chamber bacteria capable of donating electrons to the anode upon exposure to a fuel; and circulating an anode solution through the anode feed line, the anode chamber, the anode waste line, and the cathode through passages.

### BRIEF DESCRIPTION OF THE DRAWINGS

A more complete appreciation of the invention will be readily obtained by reference to the following Description of the Example Embodiments and the accompanying drawings.

FIG. 1 schematically illustrates a fuel cell.

FIG. 2 schematically illustrates a stacked fuel cell

FIG. 3 schematically illustrates a fuel cell.

FIG. 4 shows graphs of (a) current and (b) power versus run time for the mini-MFC for DSP1 0 (solid line) and Bacillus sp. (dashed line) cultures.

FIG. 5 shows calculated Coulombic efficiency deduced from lₚₘₐₓ versus run time for graphite felt (GF) (solid line) and reticulated vitreous carbon (RVC) (dashed line).

FIG. 6 shows (a) voltage and (b) power versus current for RVC mini-MFC running with (open squares) and without (solid circles) 100 μM AQDS.

FIG. 7 shows (a) voltage and (b) power versus current for GF mini-MFC running with (circles) and without (open squares) 100 μM AQDS.

FIG. 8 shows l_{sc} (open/closed squares) and lₚₘₐₓ (open/closed circles) versus flow rate for (a) GF electrodes, and (b) RVC electrodes.

FIG. 9 shows (a) current and (b) power versus time for an aerobic culture of DSP10 operating in the mini-MFC.

FIG. 10 shows (a) current versus time after pumping is stopped and (b) dissolved oxygen concentration in the anolyte and amount of lactate in the anode chamber over the same time period.

FIG. 11 shows (a) voltage and (b) power versus output current for the mediatorless aerobic and anaerobic mini-MFC.

FIG. 12 shows (a) Voltage and (b) power versus output current for the mediatorless aerobic and anaerobic mini-MFC.

### DETAILED DESCRIPTION OF EXAMPLE EMBODIMENTS

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

Some embodiments provide a scalable (micrometers to meters) power generation device based on microbial metabolic function that includes two features. First, the design enables efficient 3D stacking of cells for easily controlled voltage, current, and power. Secondly, the design includes chambers suitable for insertion of high surface area, 3D electrodes. Such electrodes can enable orders of magnitude more power generating capacity by miniature devices than prior 2D microfabricated electrodes and devices.

The design is based on two adjacent electrode chambers that are designed to house 3D electrodes. Preliminary experiments used electrodes ranging from thin, coiled wire (filaments) to high surface area foams and felts. The design is also scalable from the mm-scale to a microfluidic device, enabling a larger range of power to be generated. The design may also be efficiently stacked in three dimensions, making the wiring of serial and parallel circuits practical.

The mini-MFC described herein can utilize aligned and closely spaced electrodes as well as a large electrode surface area-to-chamber volume ratio (30-510 cm-¹). Contrary to a microfabricated design, the mini-MFC can also utilize three-dimensional (3D) electrodes that enable greater total electrode surface area (36-611 cm²) while maintaining a small cross-sectional area (2.0 cm²). These changes resulted in higher voltage and current output from the mini-MFC than previously reported for other small MFCs.

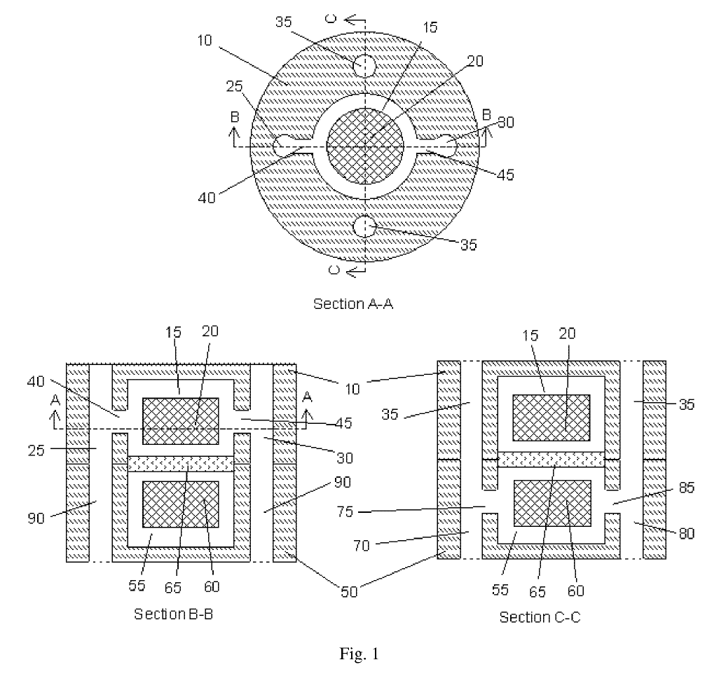

FIG. 1 schematically illustrates an embodiment of the fuel cell. The shapes and arrangements depicted are not the only possible shapes and arrangements. Section A-A is a cross-sectional view of one housing, arbitrary designated as an anode housing 10. Inside anode housing 10 is anode chamber 1 5 and anode 20. Anode housing 10 comprises anode feed passage 25, anode waste passage 30, and two anode through passages 35. The designations of feed and waste passages may be arbitrary, as fluid may be able to flow in either direction through the fuel cell. Anode feed passage 25 is coupled 40 to anode chamber 15, and anode waste passage 30 is also coupled 45 to anode chamber 15. The term “coupled” means that fluid may flow between the passage and the chamber.

Sections B-B and C-C are vertical cross-sections through two sets of passages. The passages are arbitrarily located at 90° intervals around the housings. The anode housing 10 and cathode housing 50 are shown as in direct contact, however, there may also be an intervening component or both housings may be portions of a single article. Cathode housing comprises cathode chamber 55 and cathode 60. Anode chamber 15 and cathode chamber 55 are separated by proton exchange membrane 65. Cathode feed passage 70 is coupled 75 to cathode chamber 55, and cathode waste passage 80 is also coupled 85 to cathode chamber 55. Anode feed passage 25 and anode waste passage 30 are each coupled to a cathode through passage 90, and cathode feed passage 70 and cathode waste passage 80 are each coupled to an anode through passage 35.

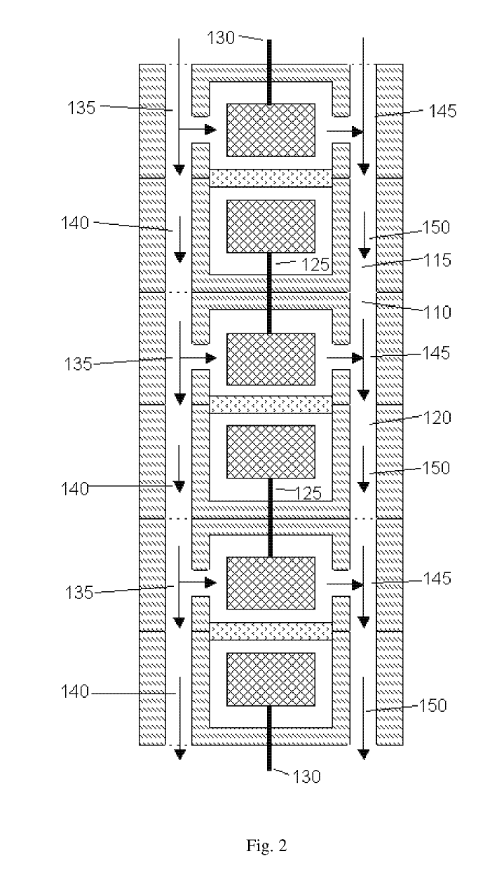

A plurality of the fuel cells may be combined to form a stacked fuel cell. This is schematically illustrated in FIG. 2. When the cells are stacked at least one anode feed passage and at least one anode waste passage is coupled to at least two cathode through passages and at least one cathode feed passage and at least one cathode waste passage is coupled to at least two anode through passages. The two through passages are each in a different housing. FIG. 2 shows three fuel cells stacked together, though the term “stacked” does not require the arrangement in FIG. 2. The fuel cells may be disconnected or in a different arrangement as long as all couplings and connections are present. Of the six half-cells in FIG. 2, all but the top-most and bottom-most contain feed and waste lines that are each directly coupled to two through passages, one in the half-cell above and one in the half cell below. For example, cathode waste line 110 is coupled to anode through passage 115 and anode through passage 120.

The stacked fuel cell also comprises one or more electrical leads. Each lead is electrically connected to an anode of one of the plurality of fuel cells and to a cathode of another of the plurality of fuel cells. This arrangement causes the fuel cells to be connected in an electrical series. Leads 125 are the series leads. FIG. 2 also shows external connecting leads 130 for connected the fuel cell or stacked fuel cell to an external circuit to be powered.

The arrows in FIG. 2 indicate how fluid may flow through the cell or cells. Arrows 135 show fluid flow in the anode feed passages. A portion of this fluid is diverted into each of the anode chambers for interaction with the anode. The remaining fluid flows through the cathode through passages as indicated by arrows 140. Similarly, fluid can flow from the anode chambers in anode waste passages as shown by arrows 145 and through cathode through passages as shown by arrows 150. The flow directions shown may be arbitrary and the feed and waste flow may independently be either up or down. The cathode fluid flow is not shown in FIG. 2, but may be similarly arranged.

The proton exchange membrane separates the anode chamber from the cathode chamber. Such membranes are known in the art of fuel cells and may be any material that allows protons to pass between the chambers. A suitable proton exchange membrane material may be, but is not limited to, perfluorosulfonic acid-polytetrafluoroethylene copolymer. This material may be commercially available as NAFION® (DuPont).

The anode may have any form having the required surface to volume ratio. Suitable forms include, but are not limited to, regular mesh and inverse mesh. Suitable anode materials include, but are not limited to, titanium foam, carbon foam, graphite felt, titanium foil, carbon paper, carbon felt, titanium microparticles, and carbon microparticles. The anode may also be coated with a conductive polymer such as, but not limited to, polyaniline, fluorinated polyaniline, poly(2,3,5,6-tetrafluoroaniline), or combinations thereof. Such a coating may allow for adhesion and/or growth of bacteria directly on the anode surface. Anode/cathode can also be coated or doped with additives as shown in the field (Pt) or novel additives such as other metals or metal oxides that may enhance electron transfer (anode) and/or oxygen reduction (cathode).

The fuel cell may also comprise an anode solution reservoir coupled to the anode feed passage and a cathode solution reservoir coupled to the cathode feed passage. The reservoirs can be a source of fluid for circulating through the fuel cell. Instead of the cathode reservoir, an air cathode, as is known in the art, may be used. When an air cathode is used, the cathode may be exposed to air containing oxygen, or oxygen dissolved in water or seawater by any opening in the cathode housing, possibly eliminating the fluidics for the cathode chamber, such as cathode feed and waste lines and the anode through passages.

Bacteria may be placed into the anode chamber so that the fuel cell operates as a biofuel cell. The bacteria are capable of donating electrons to the anode upon exposure to a fuel. The fuel cell is then operated by circulating an anode solution and a cathode solution as described above. The anode circulation may also be under aerobic or microaerophillic conditions.

The anode solution may comprise a fuel for the bacteria. Suitable fuels include, but are not limited to, glucose, lactate, and acetate. As the bacteria digest the fuel, electrons are generated that may be transferred to the anode. The anode solution may comprise an electron mediator to facilitate this transfer. As in a typical fuel cell, the electrons may then pass through an external circuit and to the cathode. The cathode solution contains an electron receptor. Suitable receptors include, but are not limited to, potassium ferricyanide and oxygen. The charge is balanced by transfer of protons from the anode chamber, through the proton exchange membrane, and into the cathode chamber.

The MFC presented here is smaller than most MFCs in the literature, and takes advantage of anode and cathode alignment and spacing to maximize proton transport across the PEM. By aligning the anode and cathode and greatly reducing the distance between them, the device could potentially operate at higher efficiencies than the traditional “H-cell” design often still used in many MFC experiments. The mini-MFC design allows high surface area, 3D electrodes to be used rather than a pattern of shallow channels in a serpentine path. Even with a relatively deep chamber (0.6 cm), the mini-MFC design can still maintain a large surface-area-to-volume ratio when graphite electrodes are used (510 cm-¹), enabling high power densities to be attained. The large surface-area-to-chamber volume ratio also decreases the average distance from any point in the fluid to an electron surface, thus improving the charge transport efficiency in the fluid.

The potential advantage of a miniature device versus macroscopic is based on the shorter diffusion paths (both for electrons to the anode and protons across the PEM) and higher surface area-to-chamber volume ratios. Most prior macroscopic MFCs may have ratios less than 1 cm²/cm³, though with some as high as 2.5 cm²/cm³ (Min et al., “Continuous electricity generation from domestic wastewater and organic substrates in a flat plate microbial fuel cell” Environ. Sci. Technol., 38, 5809 (2004)). Mini-MFC's, including the present device, may have ratios of up to 500 cm²/cm³, which enables higher power density per volume when compared to macroscopic devices.

The power per volume maximum for mediatorless operation may be as high as 500 W/m³. The previous known reported high in the literature (excluding those that utilize H₂ excreted from bacteria) was between 216-388 W/m³ (Rabaey et al. “A microbial fuel cell capable of converting glucose to electricity at high rate and efficiency” BiotechnoL Lett., 25, 1531 (2003)) and 102 W/m³ (Moon et al., “Continuous electricity production from artificial wastewater using a mediator-less microbial fuel cell” Bioresour. Technol., 97, 621 (2006)).

Even though there may be nearly 50-10⁴ cm² of electrode surface area in the anode chamber of a typical H-cell MFC, there is usually a relatively narrow pathway (2-5 cm²) for protons to traverse across the proton exchange membrane (PEM). Therefore, electron transfer to the anode can be highly efficient while proton throughput across the PEM is highly inefficient. Both proton transport through the PEM and electron transport to the anode become even more crucial when discussing an aerobic anode chamber due to the thermodynamically favorable oxygen reaction with protons and electrons to form water:

4H+(aq)+O₂(aq)+4e⁻−→2H20(l) (1)

This scavenging reaction is most likely responsible for the null power output for previous attempts at aerobic MFCs.¹⁵

The mini-MFC design can reduce diffusion lengths by placing a high surface area electrode (611 cm²) in a small volume (1.2 cm³) chamber and, optionally, by positioning the electrodes in direct contact with the PEM. This is in contrast to the H-cell design where the electrode is placed in a relatively large volume chamber and is spaced several centimeters away from the PEM. If the rate of acceptance of electrons by the anode in the mini-MFC competes with the removal of electrons via reaction (1), then measurable current should be generated, even in an aerobic environment. In addition, the entire anode chamber in the mini-MFC would then be slightly deficient in electrons (donated to anode), making the rate of reaction (1) slower, increasing the concentration of protons in the chamber and enabling a higher percentage of protons to diffuse to the PEM. This electron deficiency may occur in a traditional H-cell design, but because the anode is spaced far from the PEM, the probability of significant proton diffusion to the PEM is small in an aerobic environment based on the efficiency of reaction (1). Electrons and protons generated inside the anode chamber have a higher probability of diffusing to the anode and PEM, respectively, in the mini-MFC when compared to the H-cell design. It is predicted that power can be generated in an aerobic MFC, but the output should be reduced by oxygen scavenging when compared to an anaerobic counterpart.

Traditional serpentine-path 2D channels pose two significant problems for miniature reaction cells. First, fuel is continuously used as it is pumped through the back-and-forth channels. This flow cycle results in potentially much lower fuel concentrations at the end of the electrode surface than at the beginning. Secondly, as the device footprint becomes smaller, the channels must get smaller as well, which are more easily clogged and require lower flow rates. The mini-MFC utilizes one entrance and one exit port to create more uniform mixing and distribution of fuel and reagents in the chambers. In addition, the ports are utilized over a 1.5 cm diameter chamber, enabling each to be much larger and making them less likely to clog than corresponding serpentine-path channel that have multiple passes over a similar width.

There are two examples of “flat plate” MFCs in the literature, one microfabricated MFC with a 1.5 cm² cross-section and the other a macroscopic 100 cm² cross-section device. Chiao et al., “Micromachined microbial fuel cells,” Proceedings of IEEE Micro Electro Mechanical Systems Conference, Kyoto, Japan, January 2003, pp. 383-386 describes a microfabricated MFC that utilized an anode yeast culture, a ferricyanide catholyte, and a surface area-to-chamber volume ratio of 500 cm^{31 1}. Current and power density per true surface area (0.5 cm²) was reported to be 30-100 mA/m² and 5×10^{31 3}mW/m² with a power per volume of 0.5 W/m³. Very short run times were reported, with significant drop in output current after only 15 min. With the present mini-MFC, a similar mediatorless current density over a period of 7 days and a much higher total current and power output (1.25 mA vs. 5 μA, 0.6 mW vs. 1.25 nW) for a similar cross-section device (2 cm² vs. 1.5 cm²) were obtained. In addition, the utilization of high surface area 3D electrodes in the mini-MFC increased the power density over 3 orders of magnitude when compared to the 2D microfabricated device (461 W/m³ vs. 0.5 W/m³). The mini-MFC power per volume is on the same order of magnitude as other energy scavenging sources, making the mini-MFC a potential power source for long functioning autonomous sensors.

Min et al., “Continuous electricity generation from domestic wastewater and organic substrates in a flat plate microbial fuel cell,” Environ. Sci. Technol., 2004, 38, 5809-5814 describes a “flat plate” MFC that utilizes serpentine path electrode with a total surface area of 55 cm² and 22 cm³ chamber volumes for a surface area-to-chamber volume ratio of 2.5 cm⁻¹. This ratio is 10-100 times larger than many traditional MFCs, but 200 times smaller than the ratio for the present mini-MFC. Domestic wastewater was used in the anode, and the MFC operated with an air cathode (carbon cloth spiked with a Pt catalyst). Relatively high power densities per true surface area were found, ranging from 60-300 mW/m², depending upon the substrate used. When calculated as a function of cross-sectional area, the power density fell to 33-165 mW/m², and by using the chamber volume, the power density was calculated to be between 15-75 W/m³. In comparison, when the mediatorless mini-MFC was operated using GF electrodes, the power density increased from 9.8 mW/m² for true surface area to 3000 mW/m² when using the cross-section area, a factor of 18 times larger than the “flat plate” MFC (for pure substrates, lactate vs. acetate). In addition, due to the much higher surface-area-to-chamber volume ratio for the mini-MFC, the power density per chamber volume was over 60 times larger than that of the macroscopic “flat plate” MFC. The mini-MFC data was collected using ferricyanide rather than an air cathode, but with the use of a platinum catalyst air cathode for the “flat plate” MFC, the decrease in power density should be less than a factor of two. This assumption is supported by comparison to a tubular microbial fuel cell that utilized a ferricyanide cathode and has a power per volume over 30 fold lower than the mini-MFC (Rabaey et al., “Tubular microbial fuel cells for efficient electricity generation,” Environ. Sci. Technol., 2005, 39, 8077-8082).

The current and power density per true surface area reported here represents a stark difference when compared to macroscopic “H-cell” Shewanella sp. MFCs operating without mediators and utilizing non-chemically altered GF electrodes. Kim et al., “A mediator-less microbial fuel cell using a metal reducing bacterium, Shewanella putrefaciens,” Enzyme Microbial Technol., 2002, 30, 145-152 reported current and power densities using a Shewanella putrefaciens anolyte with a dissolved O₂ cathode. With an apparent electrode surface area of 50 cm², current and power densities were calculated to be 8 mA/m² and 0.3 mW/m². However, GF electrodes with 50 cm² of geometric surface area and 3000 cm² of true surface area were used in this study. Therefore, adjustments based on true surface area yield reduced current and power densities of 130 μA/m² and 5 μW/m². This calculation reveals that the mini-MFC, while using a ferricyanide catholyte and GF electrodes, produced 160 and 1960 times more current and power density than previously reported for a Shewanella putrefaciens MFC. The use of ferricyanide in the cathode chamber could reduce this difference by up to 8 fold, but significant differences in performance remain. Because there were no other significant differences between these experiments, it is believed that the miniature MFC design, by utilizing a high surface-area-to-chamber volume ratio as well as aligned and closely spaced electrodes, improves upon previous MFC experiments that use traditional “H-Cell” or “flat plate” technology.

Having described the invention, the following examples are given to illustrate specific applications of the invention. These specific examples are not intended to limit the scope of the invention described in this application.

### EXAMPLE

Bacterial Culture Conditions-The facultative anaerobe S. oneidensis strain DSP10 was used for all experiments. Luria-Bertani (LB) broth (Difco Laboratories, Detroit, Mich.) was inoculated with DSP10 and incubated at room temperature for 5 days with shaking at 100 rpm. After assembling the mini-MFC (described below), 20-60 mL DSP10 culture was transferred to a sterile 100 mL Erlenmeyer flask, which was then capped with a sterile rubber stopper fitted with a cotton-plugged tube open to air and two glass tubes attached to influent and effluent lines. Within 1 hr, dissolved oxygen measurements (ISO2 probe, WPI, Inc., Tampa, Fla.) for both influent and effluent lines showed that the DSP10 culture had scavenged all available dissolved O₂ (0.1±0.2 ppm). Sodium lactate as substrate was added every 1-3 days. Some bacterial cultures had the soluble electron mediator anthraquinone-2,6-disulfonate (AQDS; 100 μM) added to the anolyte.

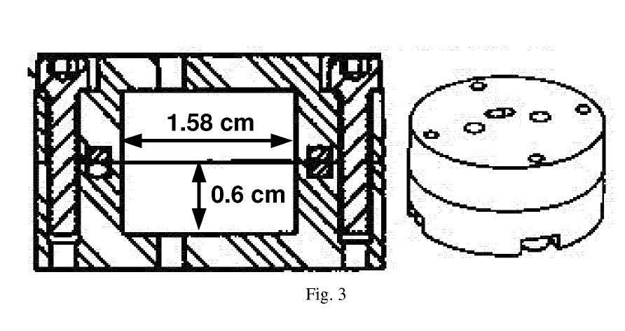

Mini-MFCassemblyand operation-The mini-MFC design (machining performed by Edmonds Engineering, Bowie, Md.) with RVC electrodes and flow tubing is shown in FIG. 3. The fuel cell chambers were made from non-conducting plastic. The cross section of the working area of the device was 2.0 cm² and the anode and cathode chamber volumes were each 1.2 cm³. Two electrodes were formed from either RVC (ERG, Oakland, Calif.; 60.7 cm²/cm³) or GF (Electrosynthesis Company, Lancaster, N.Y.; 0.47 m²/g). All experiments used a cathode and anode of equal surface area, with RVC electrodes cut to 0.6 cm³ (true surface area =36.4 cm², 1 cm² cross sectional area) and GF electrodes cut to 0.13 g (true surface area =611 cm²; volume =1.2 cm³, cross sectional area =2.0 cm²). Thin titanium wire was wound around the electrodes to ensure electrical contact. The wire was then fed through a hole in the mini-MFC chambers to connect with external loads. After 3 weeks of exposure to a DSP10 culture, electrodes were examined by environmental scanning electron microscopy (ESEM) to determine if biofilm had developed. After standard preparations, ESEM showed little to no cell attachment or biofilm formation on either electrode type.

A 175 μm thick proton exchange membrane (PEM) (Nafion® 117, Fuel Cell Store, Boulder, Colo.) was positioned between the two chambers during fuel cell operation and secured with four stainless steel screws. Both chambers were sealed by o-rings placed between the Nafion® and the outer wall. Two 0.3 cm O.D. Teflon® tubes were attached to each chamber for influent and effluent flow of anolyte and catholyte. Flow rates were set between 0.6 and 20 mL/min using a peristaltic pump (Masterflex, Cole Parmer, Vernon Hills, Ill.). The total volume of fluid residing in the influent and effluent tubing averaged 6 mL, making round trip times for fluid cycling no more than 22 min (0.6 mL/min) and no less than 0.67 min (20 mL/min). The distance between the electrodes was held constant at˜175 μm.

The catholyte in all experiments was unstirred 50 mM ferricyanide solution (Sigma-Aldrich, St. Louis, Mo.) in 100 mM phosphate buffer (pH =7.4). The anolyte was a stationary phase DSP10 culture with cell counts ranging from 1-5×10⁷ cells/mL as determined by plating. Both the mini-MFC and reagents were kept at room temperature (19° C.) for all experiments.

Data Acquisition and Calculations-Potential difference, V, between the anode and cathode were measured by a Personal DAQ/54 data acquisition system (IOTech, Cleveland, Ohio) under one of two configurations: 1) open circuit where V_{OC}=electromotive force (EMF) of the mini-MFC, or 2) closed circuit configuration, where current, I, through a load resistance, R, was calculated using Ohm's law: V=IR. Output power P was then calculated by P=IV. Voltages were recorded every 2 min by a computer with Personal DaqView software (IOTech, Cleveland, Ohio). Short circuit currents (I_{sc}) were measured with a Fluke 77 multimeter (Fluke, Inc., Everett, Wash.) when the anode and cathode were connected directly through the multimeter. Coulombic efficiency of the aerobic mini-MFC was calculated as described in previous publications (Liu et al., “Power generation in fed-batch microbial fuel cells as a function of ionic strength, temperature, and reactor configuration” Eviron. Sci. Technol. 39 (2005) 5488-5493).

The Coulombic efficiency of the mini-MFC was calculated as E=(Cₚ/C_{T)×}100%, where Cₚ is the total coulombs calculated by integrating the current over the lactate consumption time, and C_{T} is the theoretical amount of Coulombs that can be produced from the metabolism of lactate, calculated as
C_{T}=bF(mol_{lactate}) (1)
where F is Faraday's constant (96485 C/mol-electrons), b represents the number of moles of electrons produced by lactate conversion to acetate (b=4) or CO₂ and H₂O (b=12), and mollactate is the added moles of sodium lactate.

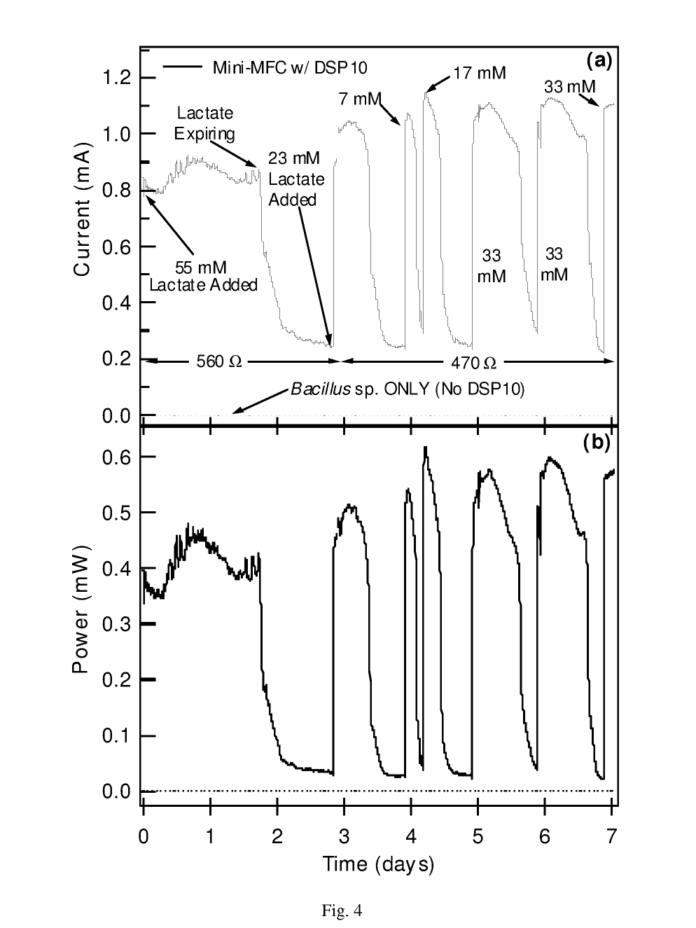

Stable current andpowerproduction-Data from the mini-MFC was obtained with either GF or RVC electrodes, and each data set was acquired in triplicate with <10% variances. Typical mediatorless function of the mini-MFC with GF electrodes is demonstrated by data shown in FIG. 4(a) taken with a constant catholyte and anolyte flow rate of 1.5 mL/min. The solid trace represents current measured in a closed circuit configuration using a DSP10 culture for the anolyte. A 560 Ω load was used for the first 2 days, and on day 3 was switched to a 470 Ω load to maintain maximum power output. Repeated cycles of lactate addition show a rapid current increase (<30 min) that was sustained initially at ˜0.8 mA and improved to 1.1 mA over the course of 7 days. Unlike some MFCs described in the literature (Park et al., “Electricity Generation in microbial fuel cells using neutral red as an electronophore,” App. Env. MicrobioL, 2000, 66, 1292-1297; Park et al., “Impact of electrode composition on electricity generation in a single-compartment fuel cell using Shewanella putrefaciens,” AppL MicrobioL BiotechnoL, 2002, 59, 58-61), lower lactate concentrations produced the same current as higher lactate concentrations (7 mM to 55 mM), although the current was sustained for shorter periods of time at lower concentrations. This result indicates that the maximum lactate consumption rate for the mini-MFC with GF electrodes was less than 10.5 μmol/min at a 1.5 mL/min flow rate. The corresponding output power for the DSP10 mini-MFC is shown in FIG. 4(b). Initial power output fluctuated from 0.37 to 0.45 mW, and successive lactate additions stabilized the performance and increased the output power from 0.55 to 0.6 mW.

The dashed lines shown in FIG. 4 are data obtained under control (blank) conditions (i.e., LB broth+lactate but no DSP10 cells). On day 2, the control became contaminated with various Bacillus sp., but closed circuit currents were never measured above 5 μA. Addition of AQDS did not improve the control performance (data not shown).

Due to the sharp current rise after the addition of substrate to the DSP10 mini-MFC and minimal current under blank conditions, it is believed that the metabolic activity of DSP10 cells was responsible for the observed current generation by the mini-MFC. In addition, data in FIGS. 4(a-b) contradict previously reported S. putrefaciens MFC data where a 50% decrease in output power was observed with repeated feedings over 7 days (Kim et al., “A mediator-less microbial fuel cell using a metal reducing bacterium, Shewanella putrefaciens,” Enzyme Microbial Technol., 2002, 30, 145-152). The observed increase in output power from the mini-MFC over time may be due to the ability of Shewanella sp. to excrete soluble quinines into the medium that aid in electron transfer to the anode. Addition of fresh DSP10 to the older culture resulted in a temporary decrease in output power, corroborating this hypothesis.

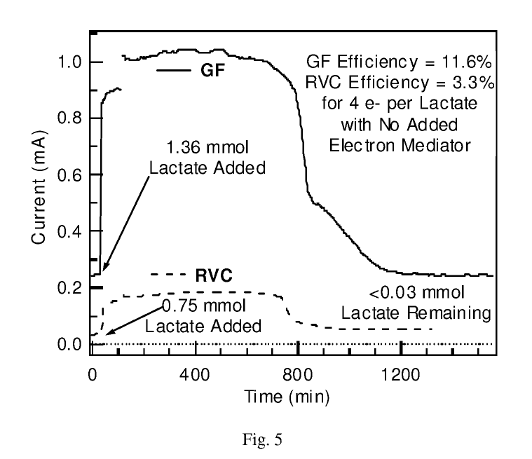

Mini-MFCefficiency-FIG. 5 is a plot of current versus run time for the addition of 1.36 and 0.75 mmol lactate to GF (solid line) and RVC (dashed line) mini-MFCs, respectively. After lactate addition, the total charge generated from the GF mini-MFC over 1500 minutes was Cₚ=61 C, whereas C_{T}=533 C (b=4) and 1600 C (b=12), yielding E=11.4±0.5% and 3.8±0.2%, respectively. FIG. 4 shows that this efficiency was maintained over the final 5 days of run time, increasing from E=9.5±0.5% (b=4) for the first 2 days when 20-30% lower current was measured. RVC electrodes under similar experimental conditions show significantly lower Coulombic efficiencies of 3.5±0.3% and 1.2±0.1% for b=4 and 12, respectively, with an average current 80% lower than that for the GF experiments.

FIG. 5 demonstrates that Coulombic efficiency of the mini-MFC depends dramatically upon the surface area of the electrodes. The significant drop in Coulombic efficiency when using RVC electrodes under mediatorless conditions is derived from the competitive processes that consume electrons during metabolic cell function, resulting in an effective drain current. This concept can be quantitatively shown for the data in FIG. 5 where the number of electrons collected by the GF anode (611 cm²) per mol lactate was 2.7×10²³ compared to the effective drain current, I_{drain}, equal to 2.1 ×10²⁴ (I_{drain}=total electrons from lactate-electrons collected by anode). When using an RVC anode (36 cm²), the collected electrons per mol lactate equaled 7.9×10²³ with a drain current of 2.3×10²⁴. It was found that the drain current was greater by only 10% for RVC, while the number of collected electrons dropped by greater than 3×. Therefore, the increase in efficiency was effectively due to the increase in current collected at the GF anode versus RVC.

The calculated Coulombic efficiency for the mini-MFC when using GF electrodes was 30% higher than the maximum value previously reported for a macroscopic S. putrefaciens MFC and nearly 200% higher after 7 days of run time (Kim et al.). That MFC used an O₂ cathode with bare GF rather than a ferricyanide reaction, which potentially reduced the current at maximum power anywhere from 25-66%, while maximum power density could be reduced by up to 8 times (Oh et al., “Proton exchange membrane and electrode surface areas as factors that affect power generation in microbial fuel cells,” AppL MicrobioL Biotechnol, 2005, early view published on-line; Oh et al., “Cathode performance as a factor in electricity generation in microbial fuel cells,” Environ. Sci. Technol., 2004, 38, 4900-4904). The improved cathode reaction may explain part but not all of the 30-200% increase in efficiency found for the mini-MFC experiment, as the current collected would also be linked to the rate of substrate consumption. It is possible that design changes such as forced convective fluid flow and reduced electrode proximity also contributed to the improved Coulombic efficiency.

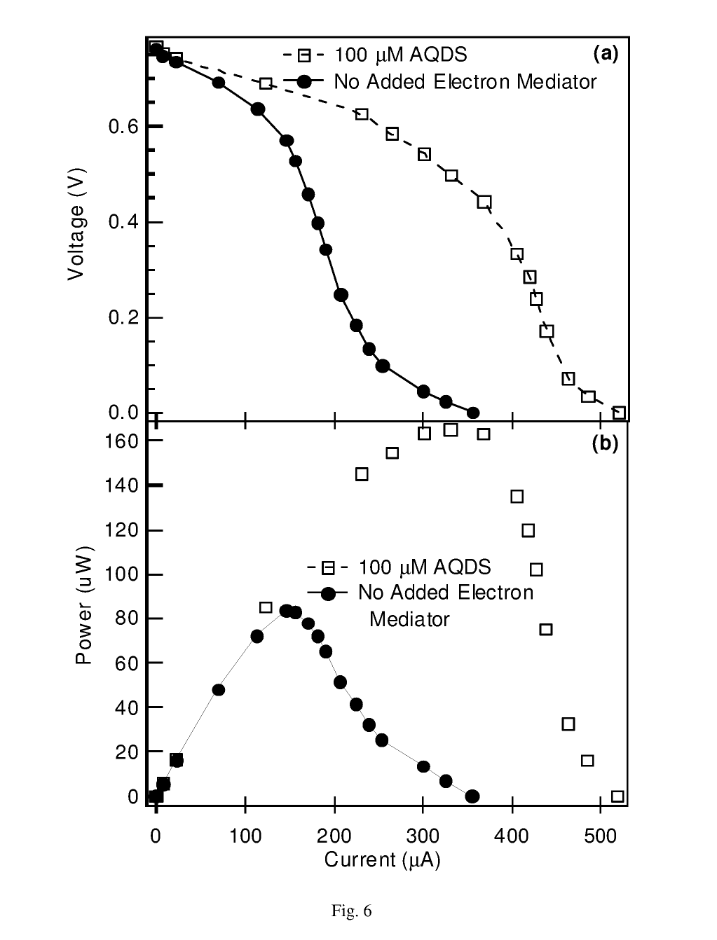

Voltage and power versus current-FIG. 6(a) is a plot of output voltage versus current for the RVC mini-MFC functioning with and without soluble electron mediator AQDS. Standard deviations of voltage measurements were less than 5% in all cases (n=4). V_{OC} remained at 0.75 V with the addition of AQDS, but the maximum output power increased by 100%. FIG. 6(b) is a plot of output power versus current for the RVC mini-MFC, with and without AQDS. The output power increased from 80 μW to 165 μW, roughly doubling with the addition of AQDS. The current at the maximum power, Iₚₘₐₓ, more than doubled from 160 μA to 350 μA. These results are indicative of the more efficient electron transfer kinetics when external soluble mediators are added to the anolyte.

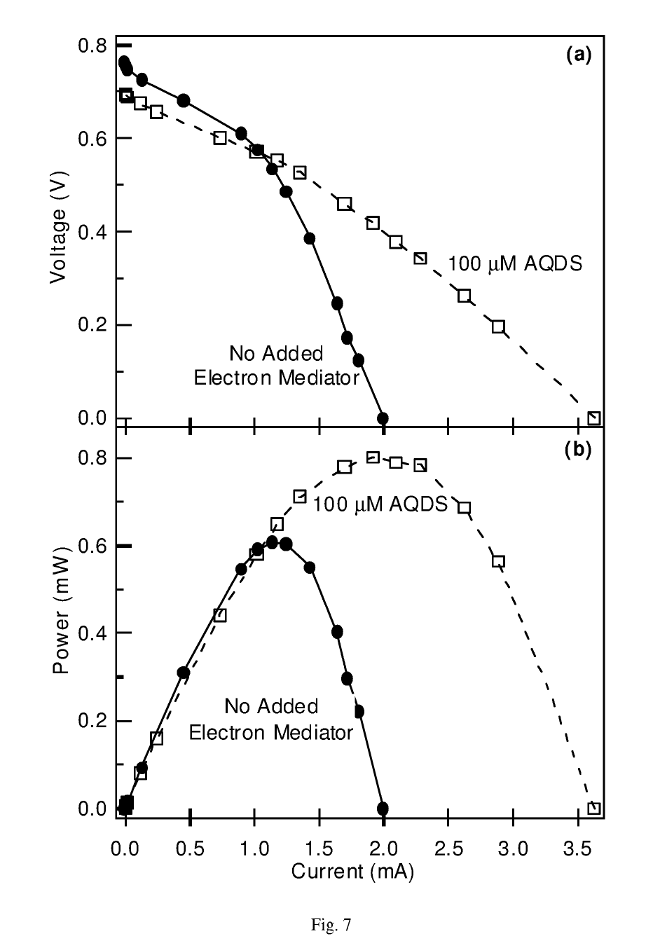

FIGS. 7(a) and (b) are plots of output voltage and power versus current for the GF mini-MFC with a 1.5 mL/min flow rate. The percent increase in true surface area for GF electrodes versus RVC was 1600%. V_{OC} of the GF cell was 0.75 V without AQDS and 0.7 V with AQDS. Similar results were observed for GF and RVC in that the addition of AQDS to the GF mini-MFC dramatically increases I_{sc} (_{3.6} mA from 2 mA), power (0.8 mW from 0.6 mW), and Iₚₘₐₓ (2.2 mA from 1.2 mA). There were also significant differences and improvements in mini-MFC performance when using higher surface area GF electrodes compared to RVC electrodes. Total output power, Iₚₘₐₓ and lsc increase by 600%, 730% and 470%, respectively, for the mediatorless fuel cell, and 385%, 535% and 590% for the mediator-enhanced fuel cell when using GF rather than RVC.

Data shown in FIGS. 6 and 7 were used to calculate the current density at maximum power and power density for the mini-MFC per true surface area, cross-sectional surface area, and anode chamber volume. Significantly higher mediatorless current density at maximum power and power density per true surface area were found for RVC (RVC =44.4 mA/m², 22.2 mW/m²) versus GF (20.5 mA/m², 9.8 mW/m²). A larger difference was found when short circuit currents were used to calculate the current density per true surface area (RVC =100 mA/m²; GF =32 mA/m²). As expected, significantly higher current and power densities were calculated when AQDS was present, and larger increases were observed for RVC (>100%) versus GF (<70%). The reduced current and power density for GF may indicate that the mini-MFC was operating at its kinetic limit when using 611 cm² of active surface area in a 1.2 cm³ chamber with a 2 cm² PEM. Another possibility may be that the reactants cannot efficiently access all of the electrode surface area during their residence time within the cell.

The more relevant metric of current and power density for miniature MFCs may be the current and power density per cross-sectional area of the device (2 cm²) or the volume of the anode chamber (1.2 cm³). For the GF mini-MFC, the cross section of the device (specifically the cross-section of the PEM) may limit the maximum output current and power (22). The density calculations based on these smaller areas and volumes reversed the previous findings, showing that GF current and power densities far outpaced RVC electrodes. By using the device cross-section, mediatorless current densities were found at maximum power and power densities for the RVC mini-MFC equal to 0.8 A/m² and 0.4 W/m², while GF electrodes yielded 6.25 A/m² and 3 W/m². Calculations based on the anode chamber volume give current and power densities for the RVC mini-MFC of 0.1 3 kA/m³ and 0.07 kW/m³, while GF electrodes yield 1.04 kA/m³ and 0.50 kW/m³. Addition of AQDS to the anolyte increased the densities for GF, giving values of 11 A/m², 4 W/m², 1.84 kA/m³ and 0.66 kW/m³ for cross section and volume calculations, respectively.

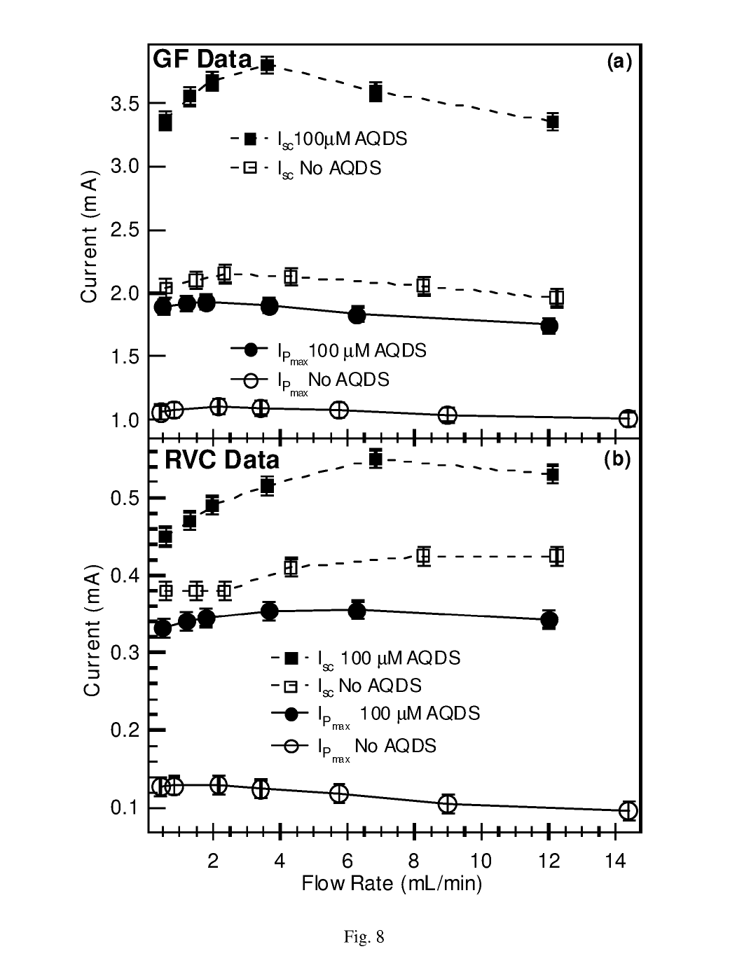

Flowrate experiments-By measuring general trends in output current with flow rate, mass transfer and kinetic limits in the mini-MFC can be studied. FIG. 8(a) shows that for a GF mini-MFC utilizing AQDS (surface-area-to-chamber volume ratio of 510 cm⁻¹), Iₚₘₐₓ was only weakly dependent on flow rate between 0.5 mllmin and 12 mL/min (closed circles), peaking at 1.9 mA (1.5 mL/min) and then dropping to 1.75 mA at higher flow rates. This is in agreement with the assertion that the process is reaction-limited at these conditions, where increasing the flow rate has only a minor effect on the output power. Under the same experimental conditions, I_{sc} (closed squares) was double Iₚₘₐₓ and peaked over 3.8 mA at nearly three times the flow rate. This data shows that I_{sc} can be increased 13% with flow rate versus 3% for Iₚₘₐₓ . Therefore, under the maximum current conditions (I_{sc} with AQDS), the mini-MFC is in a mass-transfer-limited regime and higher flow rates will have significant effect on the output current.

Open markers in FIG. 8(a) show current behavior with respect to flow rate under mediatorless operation with GF electrodes. Both I_{sc} (open squares) and Iₚₘₐₓ (open circles) reached maxima between 2 and 3 mL/min at 2.2 and 1.1 mA, respectively. It is clear from the increased output current that the introduction of a mediator significantly improved the electrode kinetics in the microbial fuel cell. Moderate gains in current can be achieved in mediatorless operation by increasing the flow rate, but the maximum gain observed is for I_{sc} and is less than 7% compared to 13% for operation with AQDS. These results are an indication that mass transfer does not play an extensive role in the mediatorless operation of the mini-MFC when high surface area-to-volume electrodes are used.

FIG. 8(b) is a plot of current versus flow rate for the RVC mini-MFC (surface-area-to-chamber volume ratio of 30 cm⁻¹). There was little increase in flow rate for Iₚₘₐₓ (open and closed circles) using RVC electrodes, suggesting sufficient mass transport and sufficiently efficient flow conditions to operate in the kinetically controlled regime of the electrode, even at low flow rates (<4 mL/min) and long reactant residence times (0.3 to 2 min). I_{sc} (open/closed squares) versus flow rate for RVC electrodes is also shown in FIG. 8(b). A marked increase in I_{sc} was found with increased flow rate, both with and without the AQDS mediator. This behavior was different than prior results in that current slowly increased throughout the entire range of flow rates, maximizing at or near the highest flow rate tested (12 mL/min). In all GF experiments, the current maximums were found at much lower flow rates between 1.5 and 4 mL/min. Maximum currents at higher flow rates would indicate that the mini-MFC operates more in a mass transport limited regime when using low surface area-to-volume electrodes than when using GF electrodes. While generating smaller currents than in the case of GF, current density using RVC was more than doubled. Electrode kinetics for the two forms of carbon are probably different, and the mass transport characteristics are almost certainly different, so it is not surprising that a mass-transport-limited flow regime was observed at lower currents than with GF. Additionally, flow profiles are probably more homogeneous for the low density (3% relative density) macroporous RVC while the folded GF may feature significant heterogeneities in available flow paths. This heterogeneity may result in inefficient sampling of the large GF surface area by either electron bearing mediators or bacteria.

Aerobic conditions-Within 10 min of placing the aerobic culture in an unstirred environment for the fuel cell experiment, dissolved oxygen measurements (ISO2 probe, WPI, Inc., Tampa, Fla.) for both influent and effluent lines showed that the DSP10 culture had scavenged all available dissolved O₂ (0.1±0.2 ppm). In order to maintain an aerobic culture, sterile air was continuously and vigorously bubbled through the anolyte flask. Dissolved oxygen in the anolyte was measured in the influent and effluent by using two dissolved oxygen probes located immediately before and after the anode chamber. Dissolved oxygen was found to be near saturation prior to the anode chamber (8-9 ppm) and at 15% of saturation after the chamber (1 ppm). These measurements show that dissolved oxygen in the anolyte was reduced during its residence time in the chamber, but that at all times during the experiment dissolved oxygen was measurable ensuring aerobic conditions.

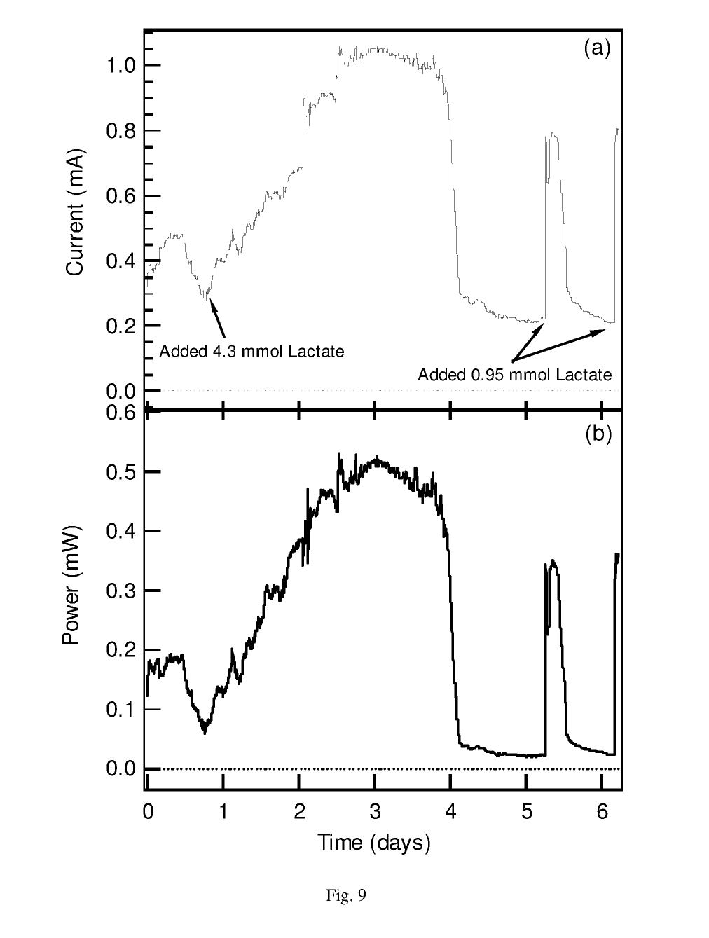

FIGS. 9(a) and (b) show mediatorless current and power generated by the mini-MFC over 6 days using an aerobic culture of DSP10 as the anolyte. Dissolved oxygen measurements throughout the experiment showed >8 ppm of oxygen in the inlet tubing and >1 ppm in the outlet tubing. The data shows a slight rise in current and power on day 1, prior to any addition of lactate. This low level of current is most likely due to DSP10 metabolism of remaining nutrients from the original LB broth. After the first day, 4.3 mmol of lactate was then added to the DSP10 , resulting in a slow and steady rise of output current and power over the course of 3 days, culminating in the highest aerobic output measured at 1 mA and 0.50 mW. After day 4, the current and power dropped sharply as the lactate was extinguished and rose again as a smaller amount of lactate was added on day 5 and again on day 6. The slightly lower current and power measured on days 5 and 6 (0.8 mA, 0.36 mW) may be due to a dependence on lactate concentration or slight changes in the concentration of DSP10 in the anolyte. Current and power output from the mini-MFC when utilizing anaerobic DSP10 did not show any concentration dependence until less than 0.5 mM lactate was present. Cell counts were taken throughout the experiment, showing relatively consistent concentrations ranging from a maximum of 5×10⁷ on day 4 to a minimum of 2×10⁷ on day 1 and day 6. It is possible that these variations in cell counts were responsible for the lower current and power observed on days 1 and 6. It is also possible that metabolites excreted by the DSP10 culture result in lower cell concentrations and output current over time. Overall this plot demonstrates constant function of the mini-MFC with an aerobic anolyte over the course of 6 days with sustained output current (≧0.80 mA) and power (≧0.36 mW).

Based on the number of usable electrons present in the added lactate substrate, the Coulombic efficiency of the aerobic mini-MFC can be calculated from the data shown in FIG. 9. Assuming 4 electrons per lactate molecule (metabolized from lactate to acetate), the Coulombic efficiency peaked at 5.5±0.4% for the addition of 4.3 mmol lactate (day 1-4) and was reduced to 3.1±0.3% for the 0.95 mmol additions of lactate. This observed reduction in efficiency is possibly a result of lower cell concentration and the need to refresh the anolyte culture. The calculated efficiency for the aerobic mini-MFC is roughly half the efficiency calculated for the anaerobic system. This reduced efficiency is most likely due to dissolved oxygen in the anode chamber that scavenges electrons via reaction (1). This scavenging reaction competes with electron diffusion to the anode, thus reducing the overall Coulombic efficiency of the system.

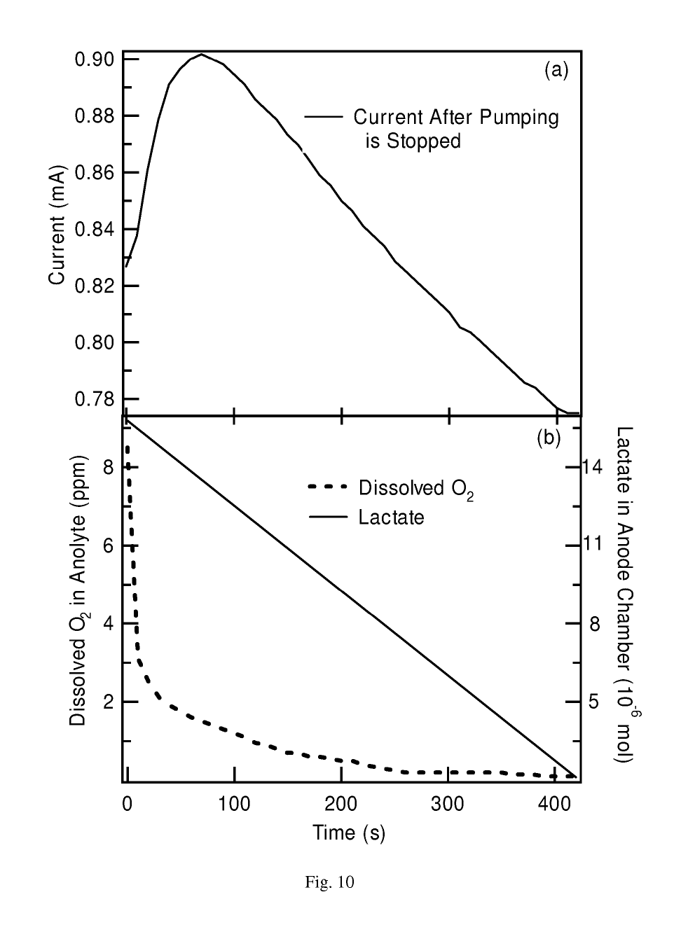

A more detailed look at the current production from the aerobic anode reveals a complex environment where oxygen scavenging, electron donation to the electrode, and lactate consumption occur simultaneously. FIG. 10(a) is a plot of output current versus time as the pumping was stopped (time 0s), while FIG. 10 (b) is a graph of both estimated lactate consumption and measured dissolved oxygen concentration over the same time period. The rate of lactate loss (2.9×10^{31 5} mmol/s) was calculated by dividing the amount of lactate added (0.95 mmol) by the consumption time (9 hr). The amount of lactate inside the anode chamber when the pump was stopped was calculated from the initial concentration (16 mM) and the free volume inside the anode chamber (˜1 mL). Because the anode and cathode chambers were sealed, fresh input of oxygenated anolyte through pumping was the only condition that maintained an aerobic environment in the anode chamber. FIG. 10(b) shows that when the pump was stopped, the dissolved oxygen concentration in the anolyte was reduced to below 2 ppm in less than 30 s. The dissolved oxygen was then more slowly reduced to produce anoxic conditions over the following 400 s. If electrons are actively being scavenged by dissolved oxygen in the anode chamber (i.e., aerobic conditions), the output current should increase when the concentration of oxygen decreases due to the stopped fluid flow (i.e., more electrons could diffuse to the electrode and more protons could diffuse to the PEM before being scavenged via reaction 1). This process is shown by the data in FIG. 10(a) as found that the current increased by nearly 10% over the first 80 s after the anolyte flow was stopped. This increase was followed by a decrease over the next 300 s that follows the estimated decrease in lactate in the anode chamber. This peaking behavior in measured output current is evidence that the anode chamber was under aerobic conditions when 1.2 mL/min flow was maintained, and quickly becomes anaerobic as the pumping was stopped.

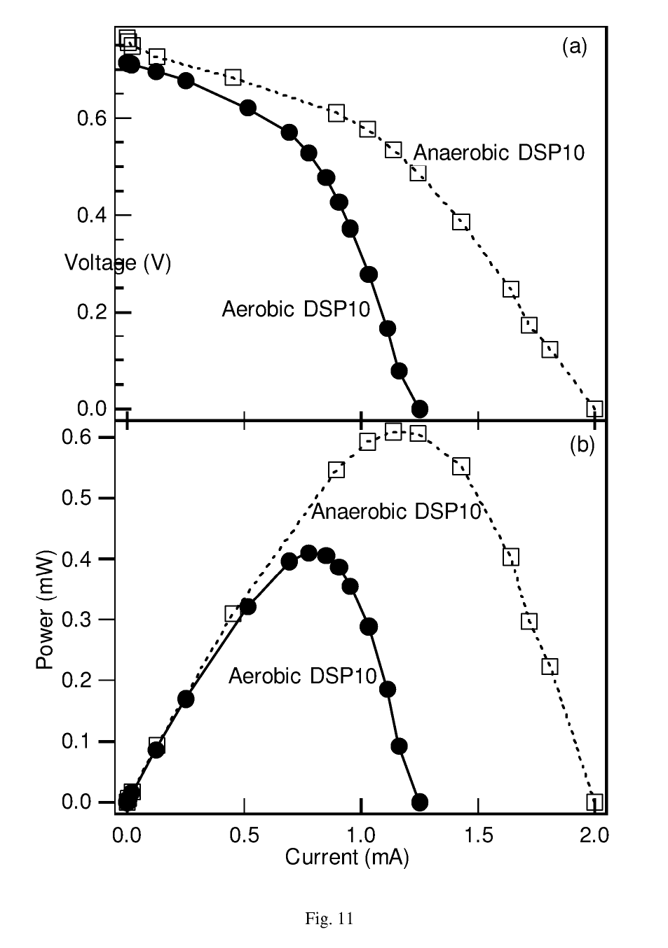

Voltage and power spectra were also measured and compared to previous results obtained using an anaerobic DSP10 culture. FIGS. 11(a) and (b) are plots of voltage and power versus output current for the mediatorless aerobic (closed circles) and anaerobic (open squares) mini-MFC. Similar open circuit voltages (0.725 V) were found for both systems, but the voltage was sustained at larger output currents for the anaerobic system than for the aerobic. Short circuit current for the aerobic mini-MFC (1.2 mA) was 37% lower than for the anaerobic culture (2.0 mA). Maximum output power (0.40 mW) and current at maximum power (0.80 mA) for the aerobic mini-MFC was 33% lower than the anaerobic system (0.60 mW, 1.2 mA). A slight reduction in output was found, but significant current and power can be generated under completely aerobic conditions.

By using the true surface area of the graphite felt anode (611 cm²), the current density at maximum power and power density of the aerobic mini-MFC were 13 mA/m² and 6.5 mW/m², respectively. The current and power density were greatly increased when the cross-sectional area (2 cm²) and anode chamber volume (1.2 cm³) were used for the calculation, resulting in 4 A/m², 0.67 kA/m³, 2.0 W/m², and 0.33 kW/m³. These current and power densities are a result of the small dimensions of the device and the large surface-area-to-chamber volume ratio (500 cm⁻¹).

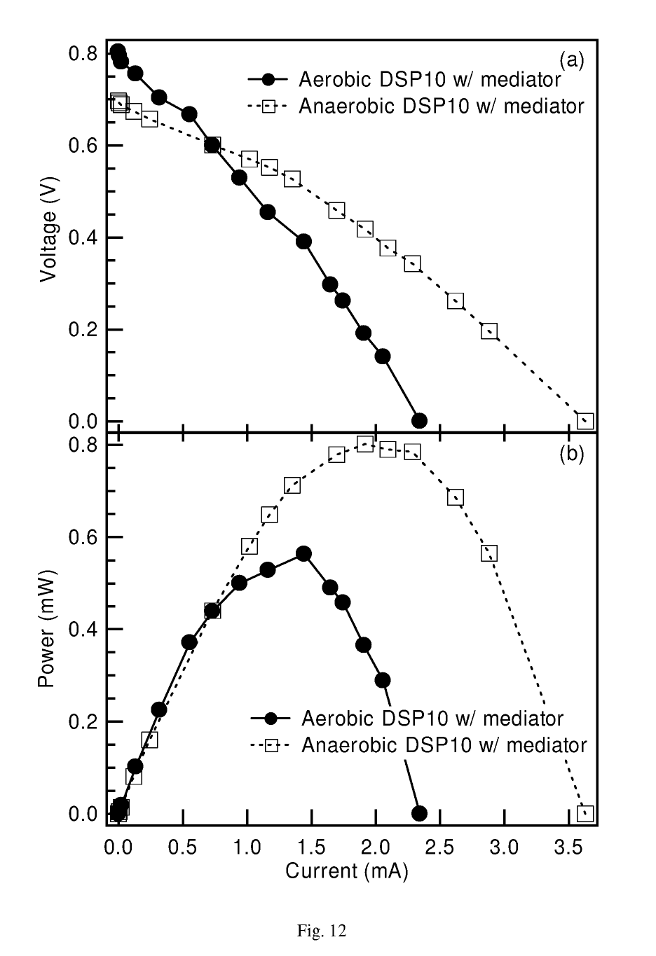

Similar current and power data were taken for the mini-MFC operating in aerobic conditions in the presence of the electron mediator anthraquinone-2,6-disulfonate (AQDS). FIGS. 12(a) and (b) are plots of voltage and power versus output current for the mediated system. Maximum current (2.4 mA), current at maximum power (1.4 mA) and maximum power (0.54 mW) for the aerobic mediated mini-MFC were each reduced by 33% when compared to the anaerobic system (open squares, dashed line; FIG. 12(b)). These results are consistent with the aerobic mediatorless system that also showed a 33% reduction in current and power when compared to the anaerobic system. However, the presence of a soluble electron mediator does enhance the performance of the aerobic mini-MFC, increasing the maximum output power by 35%.

Obviously, many modifications and variations of the present invention are possible in light of the above teachings. It is therefore to be understood that the claimed invention may be practiced otherwise than as specifically described. Any reference to claim elements in the singular, e.g., using the articles “a,” “an,” “the,” or “said” is not construed as limiting the element to the singular.

What is claimed as new and desired to be protected by Letters Patent of the United States is:

1. A fuel cell comprising:
a proton exchange membrane;
an anode housing comprising an anode feed passage and an anode waste passage;
a cathode housing comprising two cathode through passages;
a three-dimensional anode having a surface to volume ratio of about 50-5000 cm²/cm³; and
a three-dimensional cathode;
wherein the anode housing and the proton exchange membrane together define an anode chamber containing the anode within the anode housing;
wherein the cathode housing and the proton exchange membrane together define a cathode chamber containing the cathode within the cathode housing; and
wherein the anode feed passage and the anode waste passage are each coupled to the anode chamber and to one of the cathode through passages.

2. The fuel cell of claim 1, wherein the proton exchange membrane comprises perfluorosulfonic acid-polytetrafluoroethylene copolymer.

3. The fuel cell of claim 1, wherein the anode is regular mesh or inverse mesh.

4. The fuel cell of claim 1, wherein the anode comprises titanium foam, carbon foam, titanium foil, carbon paper, graphite felt, titanium microparticles, carbon microparticles, or a combination thereof.

5. The fuel cell of claim 1, wherein the anode comprises a conductive polymer coating.

6. The fuel cell of claim 5, wherein the conductive polymer coating comprises polyaniline, fluorinated polyaniline, poly(2,3,5,6-tetrafluoroaniline), or a combination thereof.

7. The fuel cell of claim 1, further comprising:
an anode solution reservoir coupled to the anode feed passage.

8. The fuel cell of claim 1;
wherein the anode housing further comprises two anode through passages;
wherein the cathode housing further comprises a cathode feed passage and a cathode waste passage; and
wherein the cathode feed passage and the cathode waste passage are each coupled to the cathode chamber and to one of the anode through passages.

9. The fuel cell of claim 8, further comprising:
a cathode solution reservoir coupled to the cathode feed passage.

10. The fuel cell of claim 1, wherein the cathode is an air cathode.

11. A stacked fuel cell comprising:
a plurality of the fuel cells of claim 1; and
one or more electrical leads;
wherein at least one anode feed passage and at least one anode waste passage is coupled to at least two cathode through passages; and
wherein each lead is electrically connected to an anode of one of the plurality of fuel cells and to a cathode of another of the plurality of fuel cells, whereby the plurality of fuel cells are connected in series.

12. The stacked fuel cell of claim 11;
wherein at least one anode housing further comprises two anode through passages;
wherein at least one cathode housing further comprises a cathode feed passage and a cathode waste passage; and
wherein at least one cathode feed passage and at least one cathode waste passage are each coupled to the cathode chamber and to at least two anode through passages.

13. A method of generating power comprising:
providing a fuel cell comprising:
a proton exchange membrane;
an anode housing comprising an anode feed passage and an anode waste passage;
a cathode housing comprising two cathode through passages;
a three-dimensional anode having a surface to volume ratio of about 50-5000 cm²/cm³; and
a cathode;
wherein the anode housing and the proton exchange membrane together define an anode chamber containing the anode within the anode housing;
wherein the cathode housing and the proton exchange membrane together define a cathode chamber containing the cathode within the cathode housing; and
wherein the anode feed passage and the anode waste passage are each coupled to the anode chamber and to one of the cathode through passages;
placing in the anode chamber bacteria capable of donating electrons to the anode upon exposure to a fuel; and
circulating an anode solution through the anode feed line, the anode chamber, the anode waste line, and the cathode through passages.

14. The method of claim 13, wherein the anode solution comprises the fuel.

15. The method of claim 14, wherein the fuel is selected from the group consisting of glucose, lactate, and acetate.

16. The method of claim 13, wherein the anode solution comprises the bacteria.

17. The method of claim 13, wherein the anode solution comprises an electron mediator

18. The method of claim 13, wherein the bacteria are on the surface of the anode.

19. The method of claim 13, further comprising: exposing the cathode to air.

20. The method of claim 13, wherein providing a fuel cell comprises providing:
a plurality of the fuel cells; and
one or more electrical leads;
wherein each anode feed passage and each anode waste passage is coupled to at least one cathode through passage; and
wherein each lead is electrically connected to an anode of one of the plurality of fuel cells and to a cathode of another of the plurality of fuel cells, whereby the plurality of fuel cells are arranged in series.

21. The method of claim 13;
wherein the anode housing further comprises two anode through passages;
wherein the cathode housing further comprises a cathode feed passage and a cathode waste passage; and
wherein the cathode feed passage and the cathode waste passage are each coupled to the cathode chamber and to one of the anode through passages;
further comprising:
circulating a cathode solution through the cathode feed line, the cathode chamber, the cathode waste line, and the anode through passages.

22. The method of claim 21, wherein the cathode solution comprises potassium ferricyanide.

23. The method of claim 21; wherein providing a fuel cell comprises providing:
a plurality of the fuel cells; and
one or more electrical leads;
wherein each anode feed passage and each anode waste passage is coupled to at least one cathode through passage; and
wherein each cathode feed passage and each cathode waste passage is coupled to at least one anode through passage; and
wherein each lead is electrically connected to an anode of one of the plurality of fuel cells and to a cathode of another of the plurality of fuel cells, whereby the plurality of fuel cells are arranged in series.

24. The method of claim 13, wherein the anode is under aerobic conditions while circulating the anode solution.
